(19) United States
(12) Patent Application Publication
(10) Pub. No.: US 2006/0192772 A1
(43) Pub. Date: Aug. 31, 2006

(54) Data control pen device

(76) Inventor: Ko Kambayashi, Cupertino, CA (US)

Correspondence Address: SHEPPARD, MULLIN, RICHTER & HAMPTON LLP, 333 SOUTH HOPE STREET, 48TH FLOOR, LOS ANGELES, CA, 90071-1448, US

(21) Appl. No.: 11/068,144

(22) Filed: Feb. 28, 2005

(51) Int. Cl. G09G 5/00

(52) U.S. Cl. 345/179

(57) ABSTRACT

A pen-like pointing device with data transfer capability is disclosed. The pen device functions as a pointing and writing device in a traditional manner. In addition, it has onboard memory and a wireless receiver, so that data and files can be transferred wirelessly from the computer to the pen device and, thereafter, transferred from the pen device to another device via a connector. The connector for transferring the data/files stored in the device memory may either be a wireless transmitter or a physical connector, such as a USB port. The pen-like pointing device may have a indicator, such as an LED, which alerts the user when data or files are stored in memory, and may also have a unique identifier and other security features. Using buttons on the pen device, a used can implement cut, copy and paste functions between a computer and another device, which may be a second computer.

### FIELD OF THE INVENTION

The present invention is related to pointing devices and data input, transfer and storage devices, and is particularly related to a pen device for use with a personal computer, such as a tablet computer.

### BACKGROUND OF THE INVENTION

The sharing of data and files stored on computer systems has become extremely commonplace. Data and files may be transferred between computers, or between a computer and another type of electronic device, such as a mobile phone, MP3 player, etc. Data sharing may be accomplished by writing the data to a removable storage medium, which is then read by a device which receives the data, or may be transferred directly between two devices. Various types of removable storage media are available for use in transferring data from a computer, including, for example, floppy disks, magnetic tape, “zip” drives, CD-R and CD-RW disks, DVD-R and DVD-RW disks, “thumb” drives, compact flash memory, memory sticks, etc. Alternatively, the devices may be linked or connected to export the data from the first device to the second device. The two devices may be directly wired together, as by a transfer cable, may be linked over a telephone line via modem, or may be connected via a local area or wide area network. While various techniques and devices are available for effecting file and data transfer, each of them has its limitations such that there is a need for improved devices and techniques for easy data and file transfer.

Pen type pointing devices (sometimes referred to as “pen devices” or “pens”) are used as user input devices with computer systems. Pen devices are particularly useful with tablet computers and “personal digital assistants” (“PDAs”) because they can be used both as a highly portable pointing device, and as a writing device. In addition, it is well known to use pen-type pointing devices are used with digitizing tablets connected to computers. The pen shape has a familiar shape and feel to the user, such that use of the device is easily mastered. Heretofore, the functionality of known pen devices has been limited to use as pointing and/or writing devices.

### SUMMARY OF THE INVENTION

The present invention is directed to a pointing device for use with a computer system, comprising a wireless receiver for receiving data from the computer system, memory for storing data received from said computer via said wireless receiver, and a connector for coupling the contents of the memory to a second electronic device. The connector may be, for example, the wireless transmitter or a USB port mounted on the device. Preferably, the pointing device has a plurality of buttons for controlling operation of the pointing device, and the buttons may be assigned to implement cut, copy and paste commands. Likewise, a button may be assigned to initiate the transfer of data stored in said memory to a second device. Preferably the memory in the pointing device is flash memory, and the device comprises a status indicator, such as a light emitting diode, for notifying the user when data is stored in the device's memory. Preferably, the device further comprises a unique identifier which may be detected by the computer or the second electronic device.

In another aspect the present invention is directed to a pen-type pointing device, comprising a rf transceiver module for wireless communication to and from a computing device, a rf transceiver control module for sending and receiving digital signals to and from said computing device via said rf transceiver module, a memory module for storing data received from said computing device for later transfer to another electronic device, a program module for controlling operation of the pointing device, and a plurality of buttons for implementing user actions.

In yet another aspect, the present invention is directed to a method of using a pen-type pointing device with a computer system, comprising, using the pointing device to highlight data to be transferred from said computer system, transmitting the highlighted data using a wireless transmitter associated with said computing device, receiving the transmitted data using a wireless receiver associated with said pointing device, storing the received data in memory in said pointing device, and thereafter, transferring said data stored in memory to another electronic device. The step of transferring the stored data may be implemented using a wireless transmitter associated with said pointing device, or by physically connecting the pointing device to the electronic device, for example using a USB connector. Preferably a visual indication is provided on the pointing device when data is stored in its memory.

### BRIEF DESCRIPTION OF THE DRAWINGS

FIG. 1 is a schematic side view of a first embodiment of the pen-like pointing device of the present invention.

FIG. 2 is a perspective view of an embodiment of the pen-like pointing device of the present invention in use with a tablet computer.

FIG. 3 is a block diagram of an embodiment of the present invention and an associated computer.

FIGS. 4A and 4B are schematic side and rear views, respectively, of another embodiment of the pen-like pointing device of the present invention.

### DETAILED DESCRIPTION

The present invention is directed to an improved pen-like pointing device of the type that is used with a computer system. The pen of the present invention may be of the type which is used in direct contact with a display screen, such as the screen of a tablet computer or PDA, or which is used with a digitizing tablet that is connected to a computer. The basic use and operation of pen devices for pointing (i.e., mouse-type operations) and writing (i.e., digitizing operations) is well known and, therefore, will not be described. While the preferred embodiments, described below, are discussed in reference to a display screen of a tablet computer, the present invention is not limited to pen devices used with tablet computers.

Various techniques may be used for sensing the position of the tip of a pen-type pointing when it is in contact with or in close proximity to the surface of a computer display screen or digitizing tablet. Known techniques for sensing the position of the pen tip, thereby enabling use of a pen as a pointing and writing device, include magnetic, capacitive, optical and rf positioning techniques. In addition to functioning as a pointing and writing device, in a known manner, the pen device of the present invention has additional capabilities for facilitating the transfer of data and files from a computer system to a second electronic device, as described below.

The terms “data” and “files” are sometimes used interchangeably but may, more accurately thought of as distinct concepts. Specifically, a file may be considered any collection of information or instructions which is stored in nonvolatile computer memory under a unique name. A file may be used, for example, to store a program or program component, a text document, a picture, video or audio content, a spreadsheet, etc. Data, on the other hand, is used to refer to some or all of the information that is contained within one or more files, such as an address contained in an address book, etc. The term “data” will be used hereinafter to refer both to complete files or collections of files (of any sort) or to information contained within one or more files.

Modern operating systems, such as the various embodiments of the ubiquitous WINDOWS® operating system licensed by the Microsoft Corporation of Redmond, Wash., provide a graphical user interface with the ability to transfer data using a “cut and paste” function. Using this functionality, data displayed in one application may be highlighted using a pointing device and then “cut” or “copied” for transfer (“pasting”) to another document/application. Cut, copy and paste operations may be used to transfer or move one or more entire files, for example, by highlighting the screen display of a file or file folder icon in a file management program and cutting or copying the highlighted icon, as represented. Cutting or copying a file or collection of files may be thought of as a file “export” operation, and pasting them may be thought of as a file “import” operation. Where computers are linked or networked, the cut, copy and paste function may be used to move data and files between the linked computers.

Where computers are not connected, the process of transferring data has, heretofore, been somewhat more complex. The data must first be highlighted or otherwise identified, generally using a pointing device. The data is then stored on a removable storage medium connected to the computer, such as a floppy disk, zip drive, CD-R disk, thumb drive, etc. The removable storage medium is then made accessible to (i.e., connected to) the target computer, such that the information is made available. This entails, for example, inserting the disk into a suitable disk drive, or connecting the thumb drive to a USB port.

The present invention is directed to a pen-type pointing device which may be used to simplify the transfer of data between computers. The pen-type pointing device comprises a memory and a wireless receiver. Data to be transferred is transmitted from the computer to the pen-type pointing device, where it is stored in memory. The transfer of data may be implemented using cut and paste functionality as normally performed using a pointing device. Thereafter, the data stored in the pen-type pointing device may be transferred to another computer using a connector on the pointing device. The connector may be, for example, a wireless transmitter or a USB or other physical connection port. Alternatively, the pointing device of the present invention may have removable memory that can be connected independently to the other device, such as by a card reader or the like.

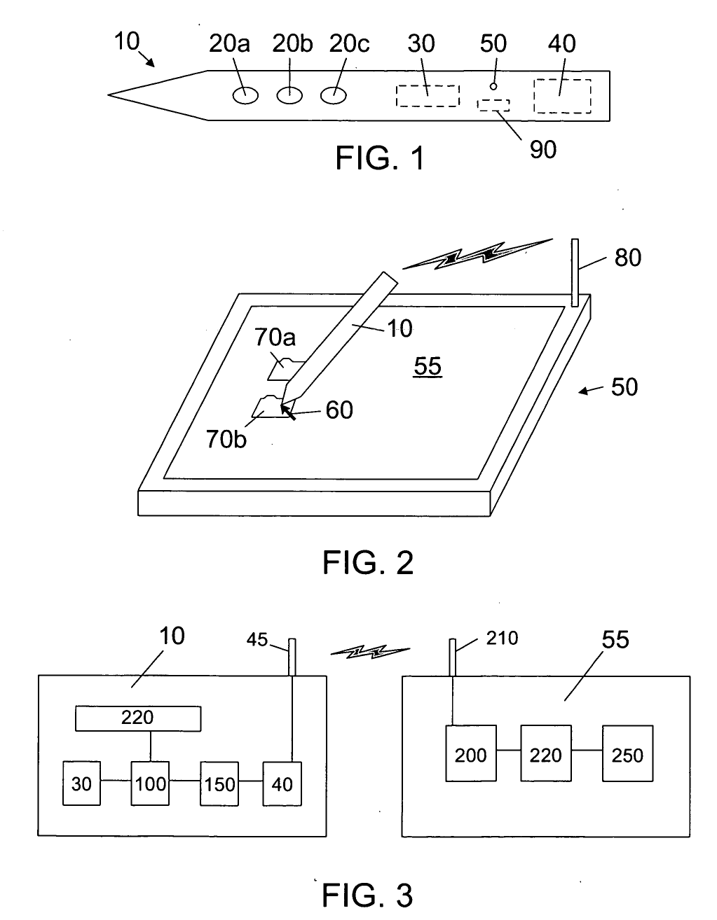

FIG. 1 depicts an embodiment of the pointing device 10 of the present invention. Device 10 has an overall pen-like shape, which makes its use and handling easy for the user to master. Those aspects of pen 10 which are related to its use as a pointing device are well known in the art and will not be described. Any of the known techniques for using a pen-like structure as a pointing device may be employed. Pointing device 10 preferably comprises a plurality of buttons 20. In the embodiment illustrated in FIG. 1, three such buttons, 20a, 20b and 20c, are shown. Preferably, the pointing device of the present invention has the ability to communicate to the computer to inform the operating system when a button is activated, and one or more of buttons 20 are used in a conventional manner as “mouse” buttons. In addition, one or more of buttons 20 may be used to implement data transfer and “cut and paste” operations. It will be appreciated that while the use of buttons are preferred, they are not essential to the present invention. Alternatively, icons for implementing the functions of buttons may be provided on the computer display and activated by pointing to them with pen 10.

Pen 10 comprises memory 30 and a wireless receiver 40. In addition, pen 10 preferably has a power source, such as a battery (not shown), and an indicator 50 which alerts the user when data is stored in memory. Memory 10 may comprise any convenient type of memory consistent with the size and power availability of the device. In a preferred embodiment, memory 10 comprises flash memory capable of storing a large amount of data. Indicator 50 may be a light emitting diode (LED), an liquid crystal display (LCD), or similar low-power device for providing visual notice to the device user that data is stored in the pen memory.

FIG. 2 is a perspective view of the pen-like pointing device 10 of FIG. 1 in operation with a tablet computer 50. The position of pen device 10 relative to the display screen 55 of tablet computer 50 is determined using any conventional technique. Depending on the mode of operation, an arrow icon 60 appears on the display screen at the location of the pen tip. FIG. 2 shows two “file” icons, 70a and 70b, displayed on computer screen 55. Alternatively, icons 70a and 70b may represent file folders, each of which may contain multiple files, such that when the file folder is cut or copied, the entire contents of the folder are thereby exported. While FIG. 2 shows file (or file folder) icons, the pointing device of the present invention can also be used to highlight, and then cut or copy, data displayed on computer screen 55. Thus, for example, a block of text, a selected portion of a picture, selected cells of a table or spreadsheet, or selected entries (or portions thereof) in a database may be highlighted and transferred in this manner.

Returning to FIG. 2, pointer 10 is used to highlight one or both of the file icons. Thereafter, by activating a designated button on the pointer, the highlighted file may be “cut” or “copied,” (i.e., exported) to memory 30 in pen 10. The file(s) are then transferred wirelessly to the pen. The wireless transfer is depicted as being transmitted from antenna 80 associated with computer 50. Antenna 80 is depicted as physically extending from a surface of the computer for illustrative purposes. Those skilled in the art will appreciate that the antenna may be entirely internal. Moreover, while the wireless transmitter is preferably built into the computer, it may, alternatively, be an add-on device, such as a PCMCIA card or the like. Preferably, the wireless transmitter operates using, for example, an rf “bluetooth” compliant transmitter. Alternatively, the wireless transmitter may be an infrared link, or may operate using any convenient rf protocol for transmitting digital data.

While the present invention has been described in connection with cut, copy and paste operations, those skilled in the art will appreciate that the memory in pen device 10 may be mapped by the operating system as a drive, and files created or modified by applications programs can be “saved” wirelessly to the pen device drive using a standard file save operation.

FIG. 3 is a block diagram of an embodiment of the pointing device of the present invention and an associated computer. Pen 10 is controlled by a controller 100, which comprise an application specific integrated circuit chip (“ASIC”) with embedded programming for implementing the desired functionality. Controller 100 is coupled to buttons 20 which are used to activate various functions. Each of buttons 20 may be permanently dedicated to a particular function, may be programmable or may be context sensitive. Depicted in FIG. 3 is computer 55 comprising, in one embodiment, an rf transmitter 200 having an associated antenna 210, and a wireless controller 220 which operate under the control of control software 250 resident on computer system. Control software 250 may be furnished as part of the operating system or may be an add on program.

To transfer data from computer 55 to pen 10, button 20 is activated to give an appropriate cut, copy or save command. Upon receiving the command, operating system 250 implements the desired function and the data is transmitted from rf transmitter 200 under the control of rf controller 220. The rf signal is received by rf receiver 40 via antenna 45 associated with pen 10, and the rf signal is decoded by wireless control module 150 and transferred to memory 30 for storage. Suitable techniques for wireless transmission and reception of digital data are well known and need not be described. When data is stored in pen memory 30, controller 100 preferably causes indicator 50 to be activated. It will be appreciated that a cut or copy operation implemented using the pen-like pointing device of the present invention may also cause the data to be temporarily stored on the computer's operating system “clipboard” in the conventional manner. Normally, data stored in the clipboard is transient and may be lost when new data is written to the clipboard, or when the computer system is turned off. Storing the data in the pen device of the present invention avoids the loss of clipboard data in this manner.

In the preferred embodiment of the present invention, multiple files may be simultaneously stored in the pen memory. Where data is cut or copied from an application into memory 30, it is preferably stored under an automatically assigned or user-designated filename. If the data is cut or copied from a file or application it may be saved as a clipboard file (for example, using the file extension “.clp”) so that it can be opened in the clipboard of the receiving device and made available for pasting into another document or application.

According to a preferred embodiment of the present invention, the data stored in pen memory 30 may thereafter be transferred to another device. To perform this transfer, pen 10 comprises a connector for transferring the data to another device. The other device may either be a second computer system or any other type of device which can utilize data from computer 50. It has become common to transfer computer files to other devices, including, for example, mobile phones, personal digital assistants (PDAs), MP3 players, etc.

As described, pen 10 comprises a connector which permits transfer of the data to another device. In one embodiment, the connector is a wireless transmitter. In such a case, pen 10 would preferably have an rf transceiver, i.e., a device capable of both receiving and transmitting the data wirelessly. Alternatively, the connector may comprise a physical port, such as a USB connector, for directly attaching the pen device to the other device. In one embodiment, pen 10 comprises both a wireless transceiver and a USB port, such that data can be downloaded using either type of connector. This adds versatility, enabling the pen of the present invention to transfer data to a wider variety of devices. In addition, the pen memory may be removable, and independently connected to the other device.

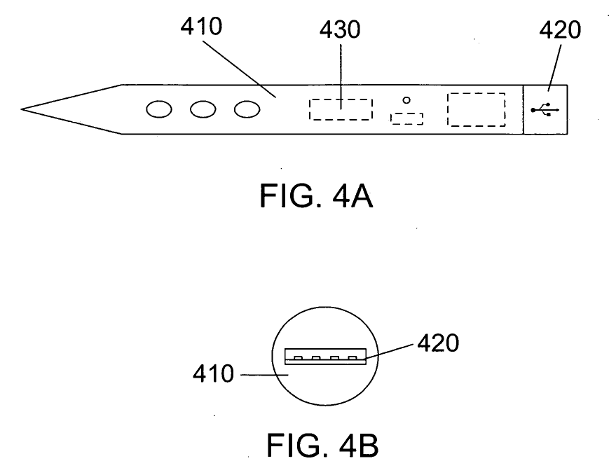

FIGS. 4A and 4B are side and rear views, respectively, of another embodiment of the pen-like pointing device of the present invention. Pen 410 shown in these figures is similar to pen 10 shown in FIG. 1, but also comprises a USB plug 420 which may be used as a connector for transferring data stored in memory 430 to another device. The physical layout of USB plug 420 and its mode of operation are in accordance with industry standards, and need not be described in detail. While a USB connector is preferred because of its widespread use in the industry, any suitable physical connector may be used instead. When pointing device 410 comprises a USB port, the device may also be used as a thumb drive in a conventional manner, such that data can be stored in memory 430 via USB plug 420, and thereafter downloaded from memory 430 via the USB plug.

As noted, preferably multiple files may be stored in pen memory 30. In such a case it is also preferable that the pen memory is treated (mapped) by the operating system of the receiving computer as a “drive,” such that the user is provided with the option of accessing or viewing the files stored in the pen memory directly, loading one or more files directly into an application program using, for example, a “file open” command, and/or selecting which of the stored files to transfer onto the receiving computer's permanent memory. For purposes of the present invention, any of these operations are considered transferring the data to the second device.

Specific types of devices may only recognize specific types of stored files, and the pen may be programmed accordingly. Thus, for example, when connected to an MP3 player, pen 10 may be programmed to transfer only MP3 files.

In a preferred embodiment, pen-like pointing device 10 has an embedded identification code 90, as depicted in FIG. 1. Code 90, which may be burned into controller 100 or may be stored in a separate ROM, PROM or EPROM device, preferably uniquely identifies the pen device. Code 90 may be used for security purposes, to prevent the unauthorized transfer of data to or from another device. In addition, the identification code can be used to initiate a log-in operation for a user associated with the pen. Additional security features, for example password protection, may be built into the device, thereby limiting access to data stored in memory.

What is claimed is:

1. A pointing device for use with a computer system, comprising:
a wireless receiver located in said pointing device for receiving data from said computer system,
memory for storing data received from said computer via said wireless receiver in said pointing device, and
a connector for transferring data stored in memory in said pointing device to a second electronic device.

2. The pointing device of claim 1 wherein said connector is said wireless transmitter.

3. The pointing device of claim 1 wherein said connector is a USB port mounted on said device.

4. The pointing device of claim 1 further comprising a plurality of buttons for controlling the transfer of data to and from said pointing device.

5. The pointing device of claim 4 wherein there are at least three button and wherein different buttons are assigned to implement cut, copy and paste commands.

6. The pointing device of claim 1 comprising both a wireless transmitter and a USB port.

7. The pointing device of claim 1 wherein said memory is flash memory.

8. The pointing device of claim 1 further comprising a status indicator for notifying the user when data is stored in said memory.

9. The pointing device of claim 8 wherein said status indicator is a light.

10. The pointing device of claim 1 wherein said pointing device comprises a unique identifier.

11. The pointing device of claim 7 wherein said flash memory is removable.

12. A pen-type pointing device, comprising:
a rf receiver module for receiving wireless communications from a computing device,
a rf control module for controlling the receipt of said wireless communication and deriving digital signals sent from said computing device via said rf transceiver module,
a memory module for storing data received from said computing device for later transfer to another electronic device,
an program module for controlling operation of the pointing device, and
a plurality of buttons for implementing user actions.

13. A method of using a pen-type pointing device with a computer system, comprising:
using said pointing device to highlight data stored in memory in the computer system to be transferred,
transmitting said highlighted data using a wireless transmitter associated with said computing device,
receiving said transmitted data using a wireless receiver associated with said pointing device,
storing said received data in memory in said pointing device, and
thereafter, transferring said data stored in memory to an electronic device.

14. The method of claim 13 wherein the step of transferring said stored data is implemented using a wireless transmitter associated within said pointing device.

15. The method of claim 13 wherein the step of transferring said stored data is implemented using a USB connector on said pointing device.

16. The method of claim 13 further comprising the step of providing a visual indication on said pointing device when data is stored in said memory.

17. A pen-like pointing device comprising:
a wireless transceiver for sending and receiving digital data to and from a tablet computing device,
non-volatile memory for storing data received from the computing device via said wireless transceiver,
a plurality of buttons, at least one of said button being programmed to activate data transfer from the computing device to said non-volatile memory,
a connector for transferring data from said pen-like pointing device to another device.

18. The pen-like pointing device of claim 17, wherein said connector comprises a USB connector.
